(19) United States
(12) Patent Application Publication
(10) Pub. No.: US 2025/0195309 A1
(43) Pub. Date: Jun. 19, 2025

(54) IONIC WIND AIRFLOW FOR INFANT INCUBATORS

(71) Applicant: GE Precision Healthcare LLC, Waukesha, WI (US)

(72) Inventors: Daniel Garcia, Pewaukee, WI (US); Helge Klockow, New Berlin, WI (US); Gabriel Searles, Wauwatosa, WI (US); Steven Falk, Baltimore, MD (US)

(21) Appl. No.: 18/544,672

(22) Filed: Dec. 19, 2023

(51) Int. Cl. A61G 11/00

(52) U.S. Cl. CPC A61G 11/00

(57) ABSTRACT

Infant incubator systems are described that incorporate an ionic wind airflow system for generating airflow without acoustic noise or vibration that results from usage of conventional motorized fan airflow systems. In an example, an infant incubator can comprise a chamber adapted to enclose or partially enclose an infant placed therein, and an airflow system, comprising one or more ionic wind modules that generate an ionic wind airflow within the chamber.

### TECHNICAL FIELD

This application relates to infant incubator systems, and more particularly to infant incubator systems incorporating an ionic wind airflow system for generating airflow without acoustic noise or vibration that results from usage of conventional motorized fan airflow systems.

### BACKGROUND

An infant incubator is a medical device designed to provide a controlled and protective environment for premature or ill newborns, commonly referred to as infants or neonates. Infant incubators play a critical role in neonatal care, especially for premature infants or those born with health complications. They offer a secure environment that promotes the development and well-being of these vulnerable newborns until they are stable enough to thrive outside the incubator. For example, a closed infant incubator, also known as an enclosed or isolate incubator, is one type of infant incubator in which the secure environment is maintained within an enclosed chamber within which the infant is placed, creating a barrier between the infant and the surrounding environment. This design helps create a microenvironment that mimics the conditions of the womb, providing the necessary support for the infant's development until they are stable enough to thrive outside the incubator.

In this regard, the primary purpose of an infant incubator is to create a warm and stable environment that helps regulate the baby's body temperature, minimize heat loss, and reduce the risk of infections. To facilitate this end, enclosed infant incubators incorporate complex environmental control systems that control temperature, humidity, oxygen and airflow within the infant chamber. Conventional environmental control systems used in enclosed infant incubators employ motorized fans to provide air circulation and facilitate temperature regulation, humidity control, and oxygen distribution in association creating a uniform and stable environment within the infant chamber. However, the motorized fan generates noise and vibration, which can have adverse effects on infants within an incubator, particularly for premature or ill newborns who are highly sensitive and vulnerable.

For example, loud noises or vibrations can be stressful for infants and excessive noise or vibration can disturb their sleep and increase cortisol levels, potentially affecting their overall well-being. Research has shown that exposure to loud noises can lead to changes in heart rate, respiratory rate, and oxygen saturation levels in infants. In addition, premature infants are often in the crucial stage of development, including the development of their auditory system, and excessive noise can potentially interfere with this process and affect hearing development. Further, stressors such as noise and vibration can cause infants to use more energy and oxygen, potentially impacting their oxygen saturation levels. For infants with respiratory issues, this increased demand for oxygen can be problematic. Furthermore, prolonged exposure to loud noises has been associated with adverse effects on neurodevelopment in infants. The developing brain is sensitive to external stimuli, and disturbances in the environment may impact cognitive and sensory development.

To mitigate these potential effects, neonatal care units and incubator manufacturers seek measures to minimize noise and vibration levels within the incubator environment.

### SUMMARY

The following presents a summary to provide a basic understanding of one or more embodiments of the invention. This summary is not intended to identify key or critical elements or delineate any scope of the different embodiments or any scope of the claims. Its sole purpose is to present concepts in a simplified form as a prelude to the more detailed description that is presented later. In one or more embodiments, systems, computer-implemented methods, apparatus and/or computer program products are described for generating airflow within an infant incubator using ionic wind technology.

According to an embodiment, an infant incubator is described that comprises a chamber adapted to enclose or partially enclose an infant placed therein, and an airflow system, comprising one or more ionic wind modules that generate an ionic wind airflow within the chamber. For example, the one or more ionic wind modules can be used within the infant incubator to create airflow instead of using a motorized fan. To this end, the one or more ionic wind modules generate the ionic wind airflow without generation of acoustic noise or vibration.

In some embodiments, elements described in connection with the disclosed systems can be embodied in different forms such as a computer-implemented method, a computer program product, or another form.

### DESCRIPTION OF THE DRAWINGS

FIGS. 1A-1C present an example infant incubator incorporating a motorized fan airflow system in accordance with one or more embodiments of the disclosed subject matter.

FIG. 2 illustrates the phenomenon of ionic wind in accordance with one or more embodiments of the disclosed subject matter.

FIG. 3 presents an example ionic wind airflow system in accordance with one or more embodiments of the disclosed subject matter.

FIG. 4 presents different ionic wind module configurations for generating varying amounts of total mass airflow, in accordance with one or more embodiments of the disclosed subject matter.

FIG. 5 illustrates an example infant incubator incorporating an ionic wind airflow system in accordance with one or more embodiments of the disclosed subject matter.

FIG. 6 illustrates another example infant incubator incorporating an ionic wind airflow system in accordance with one or more embodiments of the disclosed subject matter.

FIG. 7 illustrates another example infant incubator incorporating an ionic wind airflow system in accordance with one or more embodiments of the disclosed subject matter.

FIG. 8 illustrates a block diagram of an example infant incubator incorporating an ionic wind airflow system in accordance with one or more embodiments of the disclosed subject matter.

FIG. 9 illustrates a block diagram of an example, non-limiting computer implemented method that facilitates creating a stable environment within an infant incubator using an ionic wind airflow system, in accordance with one or more embodiments of the disclosed subject matter.

FIG. 10 illustrates a block diagram of another example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background section, Summary section or in the Detailed Description section.

One or more embodiments are now described with reference to the drawings, wherein like referenced numerals are used to refer to like elements throughout. It should be appreciated that the various structures depicted in the drawings are merely exemplary and may not be drawn to scale. In the following description, for purposes of explanation, numerous specific details are set forth in order to provide a more thorough understanding of the one or more embodiments. It is evident, however, in various cases, that the one or more embodiments can be practiced these specific details. In addition, certain elements may be left out of particular views for the sake of clarity and/or simplicity when explanations are not necessarily focused on the omitted elements. Moreover, the same or similar reference numbers used throughout the drawings are used to denote the same or similar features, elements, or structures, and thus, a detailed explanation of the same or similar features, elements, or structures will not be repeated for each of the drawings.

As used herein, unless otherwise specified, terms such as on, overlying, atop, on top, positioned on, or positioned atop mean that a first component is present on a second component, wherein intervening components may be present between the first component and the second component. As used herein, unless otherwise specified, the term directly used in connection with the terms on, overlying, atop, on top, positioned, positioned atop, contacting, directly contacting, or the term direct contact, mean that a first component and a second component are connected without any intervening components between them. As used herein, terms such as upper, lower, top, bottom, frontside, backside, above, below, directly above, directly below, aligned with, adjacent to, right, left, vertical, horizontal, and derivatives thereof shall relate to the disclosed structures as oriented in the drawing figures.

As used herein, unless otherwise specified, the terms “side,” “end,” and variations thereof, as used to described a physical object (e.g., an infant incubator and respective physical components thereof) assumes the side or end is defined by a physical element or structure having at least one surface. Unless otherwise specified, the term “open” as used to describe a side or end is used to indicate that at least one region or area of the physical element or structure associated with the side or end is open or exposed. As used herein, unless otherwise specified the term inside, internal and variants thereof as used to describe a surface of a physical element or structure is used to indicate the surface facing the three-dimensional center point of object to which the physical element or structures is attached. The term external, outside and variants thereof as used to describe a surface of a physical element or structure is used to indicate the surface opposing the internal surface.

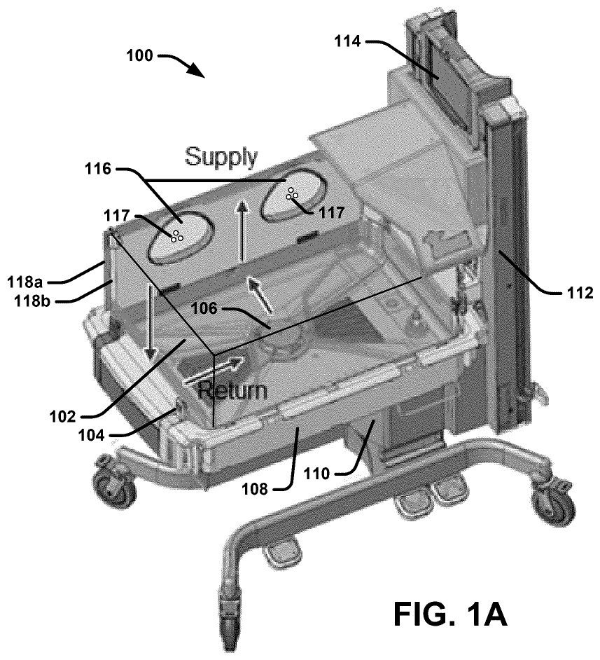

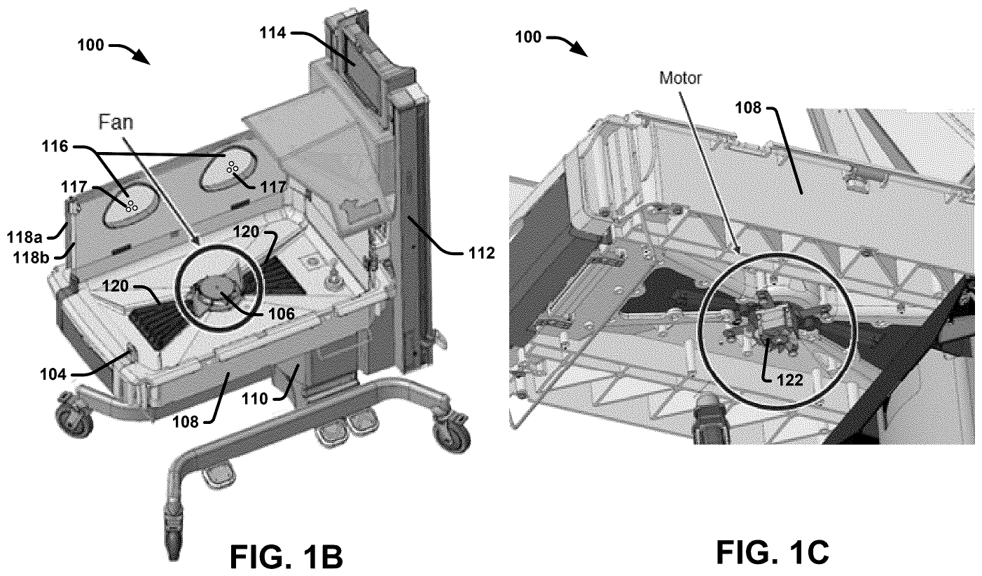

Turning now to the drawings, FIGS. 1A-1C present an example infant incubator 100 incorporating a motorized fan airflow system in accordance with one or more embodiments of the disclosed subject matter. FIG. 1A illustrates a perspective of infant incubator 100 with the chamber 102 enclosed. FIG. 1B illustrates another perspective of infant incubator 100 with a portion of the chamber 102 removed. FIG. 1C illustrates an enlarged perspective of the underside of the chamber 102.

With reference to FIGS. 1A-1C, in various embodiments, infant incubator 100 corresponds to a closed infant incubator. A closed infant incubator, also known as an enclosed or isolate incubator, is one type of infant incubator that generates a secure environment within an enclosed or partially enclosed chamber within which the infant is placed, creating a barrier between the infant and the surrounding environment. This design helps create a microenvironment that mimics the conditions of the womb, providing the necessary support for the infant's development until they are stable enough to thrive outside the incubator. For example, infant incubator 100 includes a chamber 102 adapted to enclose or partially enclose an infant placed therein. As illustrated in FIG. 1A, chamber 102 corresponds to a rectangular box defined by a topside, a bottom side opposite the topside and four sidewalls. However, the geometry of chamber 102 is variable. The portions of the chamber 102 that form at least some of the sidewalls and the topside are typically formed out of a transparent or semi-transparent material such as glass, acrylic glass (i.e., plexiglass), or the like, so that medical personnel can observe the infant continually.

Chamber 102 can include one or more doors, windows, or the like, adapted to open and close to allow placement and removal of the infant therein and to allow for accessing the infant as placed therein in association with providing medical care thereto. The specific design of such doors, windows, etc. can vary. For example, in some implementations, the topside of chamber 102 can include or correspond to a hood adapted to open and close. Additionally, or alternatively, at least one sidewall of chamber 102 can include a door adapted to open and close. In some embodiments, at least one sidewall of chamber 102 can be formed with double walled doors. For example, as illustrated in FIGS. 1A and 1B, the sidewall of chamber 102 including portholes 116 corresponds to doubled wall doors. The double wall doors are respectively defined by an exterior door 118a and an interior door 118b. In accordance with these embodiments, both the interior door 118b and the exterior door 118a can be adapted to open and close separately and/or as single unit. For example, the interior door 118b can include portholes 116 (e.g., openings) that can be exposed when the exterior door 118a is open to allow for accessing an infant placed within the chamber 102 with minimal disruption to the microenvironment established therein. The portholes 116 may also occasionally be opened to cool the chamber 102 and also incidentally exchange air with the outside environment as caregivers gain access to the infant. In some implementations, the portholes 116 are lined with grommets that prevent air from escaping between the double walled doors. The interior door 118b can also be opened to allow greater access and/or to facilitate placement and removal of the infant within the chamber 102.

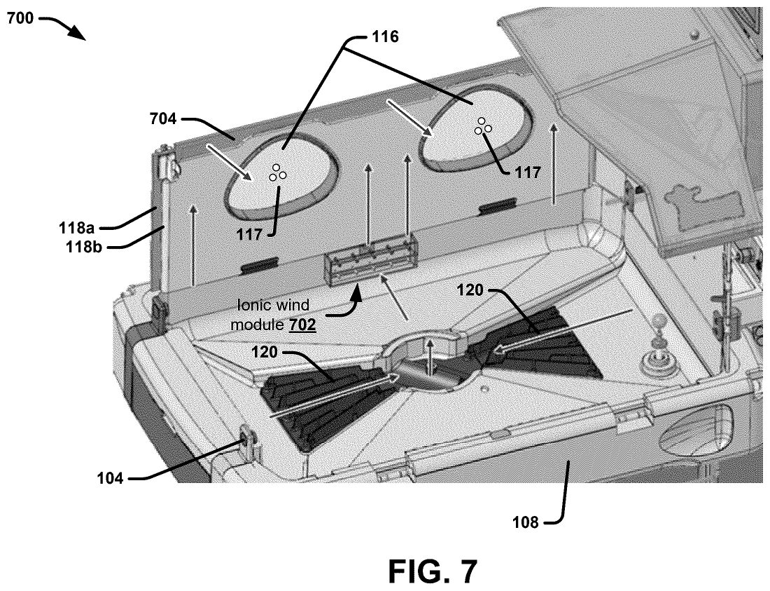

To this end, the exterior door 118a and the interior door 118b can be defined as two parallel panels of material. In some embodiments, these parallel panels (e.g., the exterior door 118a and the interior door 118b) are separated from one another via a small gap, creating an open region between the panels through which air can be circulated (e.g., open region 704 as illustrated in FIG. 7). With these embodiments, chamber 102 can include at least one airflow opening from the open region into the interior of the chamber where the infant is placed to allow delivery of air from the open region into the chamber 102. For example, in some implementations, one or more airflow openings may be formed through the interior door 118b. Additionally, or alternatively, at least one airflow opening can be formed along the upper length of the interior door 118b. For example, with reference briefly to FIG. 7, at least portions of the height of the interior door 118b may be slightly less than the height of the exterior door 118a such that air can flow between the respective panels and into the chamber 102 via one or more gaps established between the upper edge of the interior door 118b and the topside or roof of the chamber.

In some embodiments, chamber 102 can include one or more air vents or openings designed to allow for controlled airflow and exchange of gases while maintaining a controlled and stable environment for the infant within the chamber 102. The number, size and locations of such air vents or openings can vary. For example, chamber 102 can include an inlet opening 104 formed through another sidewall (other than the doubled walled doors) that serves as an airflow influx opening through which external air is drawn into the chamber 102 via the airflow system employed by the infant incubator 100. In some embodiments, inlet opening 104 can be exposed and sealed via a removable enclosure (e.g., a cap, a lid, or the like). Chamber 102 can also include one or more outlet or exhaust openings via which air can be circulated out of the chamber 102 to the external environment. For example, in some implementations, outlet openings 117 can be formed through portions of the exterior door via which air can be circulated out of the chamber 102. It should be appreciated however that air vents and/or openings via which air can be drawn into the chamber 102 and circulated out of the chamber 102 may additionally, or alternatively be formed on or within other portions of the chamber 102.

The primary purpose of infant incubator 100 is to create a warm and stable environment that helps regulate the infant's body temperature, minimize heat loss, and reduce the risk of infections. To facilitate this end, infant incubator 100 can include one or more environmental control systems that control temperature, humidity, oxygen and airflow within the chamber 102. In accordance with the embodiment illustrated in FIGS. 1A-IC, infant incubator 100 includes an environmental control system that employs a motorized fan (e.g., comprising a fan 106 and a motor 122 that drives the fan 106) to generate airflow within the chamber 102. In particular, the motorized fan is integrated within a platform structure 108 that defines the base of the chamber 102. The platform structure 108 (and the chamber 102 formed thereon) is positioned on a support frame 110 that may include or correspond to a trolly that enables the entirety of the infant incubator 100 to be easily moved. The platform structure 108 also includes a heating element 120 (e.g., a heat sink) that provides a controlled source of heat into the chamber 102. Although not shown, it should be appreciated that one or more layers of material can be formed within the chamber 102 over the fan 106 and the heating element 120 that prevent the infant from directly contacting the fan 106 and the heating element 120. Typically, the one or more layers include a bed pan and/or a bedding layer positioned within the chamber 102 over the fan 106 and heating element 122 upon which the infant is placed.

Infant incubator 100 employs the motorized fan (e.g., fan 106 and motor 122) and a duct system to circulate air warmed by the heating element 120 throughout the chamber 102 in accordance with a predefined airflow pattern. The fan output in cubic feet per minute and depends on the ducting static pressure, the fan blade design and the fan speed. The predefined airflow pattern at least partially follows along the path of the arrowed lines drawn relative to the chamber 102 as illustrated in FIG. 1A. To this end, the fan 106 draws fresh air from the external environment through inlet opening 104 and blows the air over and/or through the heating element 102. In some embodiments, the platform structure 108 can also include a humidifier (e.g., including a water container or the like) over which the fan blows the heated air to dampen the air and maintain a desired humidity level within the chamber 102. The infant incubator 100 may also include a control value via which additional oxygen can be supplied to the air. The fan 106 further blows the heated (and optionally moistened and enriched) air toward the doubled walled doors (e.g., exterior door 118a and interior door 118b) through one or more ducts or channels established between the fan 106 and the one or more layers of material (not shown) can be formed within the chamber 102 over the fan 106 and the heating element 120 that prevent the infant from directly contacting the fan 106 and the heating element 120. These one or more ducts or channels connect to the open region (e.g., open region 704) between the respective panels of the double walled doors, and direct the airflow through the open region and into the interior of the chamber 102 via one or more openings or channels that connect the open region to interior portion of the chamber 102 where the infant is placed (e.g., the portholes 117, slots at the upper edge of the interior door 118b, or the like). The fan 106 further draws and circulates at least some of the air back through one or more return channels that connect the interior portion of the chamber back to the heating element 120 and some of the air out one or more exhaust openings (e.g., outlet openings 117 or the like). To this end, without the fan 106 (or another type of airflow generator), heat cannot be conducted away from the heating element 120 and the heating element 120, and thus the infant incubator 100, would overheat.

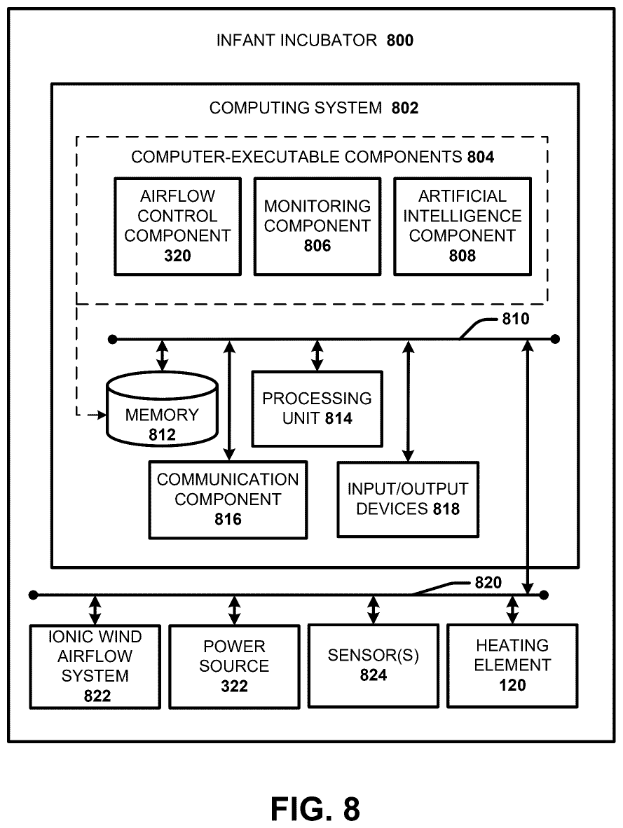

The heating element 120, the fan 106, and various other electromechanical components of the infant incubator 100 are controlled via respective control units that are communicatively and operatively (e.g., via one or more wires or wireless connections) to the electromechanical components. In various embodiments, the one or more control units can include or correspond to computer-executable components that are executed via one or more computing systems (e.g., comprising a memory that stores the executable components and a processor that executes the components stored in the memory), such as computing system 802 shown in FIG. 8. The one or more computing systems may be integrated on or within the infant incubator 100 and/or an external device that is communicatively coupled to the infant incubator 100. For example, in some embodiments, the one or more control units can be executed by a computing system that is integrated on or within a back panel 112 of the infant incubator 100. In various embodiments, the computing system can include or be operatively coupled to a display monitor 114 and/or one or more other suitable input/output devices. In some implementations, the display monitor 114 can include a touchscreen display that provides an interactive interface via which users can provide input in association with manually setting and controlling operations of the various integrated systems of the infant incubator 100 (e.g., the environmental control systems and other systems). Additionally, or alternatively, the computing system can track and display relevant information via the display monitor, such as information indicating current and/or tracked environmental parameters of the infant incubator (e.g., airflow parameters, temperature parameters, humidity parameters, oxygen levels).

As noted in the background section, the motorized fan generates noise and vibration, which can have adverse effects on infants within an incubator, particularly for premature or ill newborns who are highly sensitive and vulnerable. In accordance with the disclosed techniques, the motorized fan of infant incubator 100 is replaced by one or more ionic wind modules that generate an ionic wind airflow within the chamber 102, thereby eliminating any noise and vibration caused by usage of a motorized fan.

Ionic wind, also known as electrohydrodynamic (EHD) or electro-aerodynamic flow, is a phenomenon in which air molecules are moved by the motion of ions in the presence of an electric field. The process begins with the introduction of a high voltage potential between a source and a sink. The source is typically an electrode with a high voltage applied to it, while the sink is grounded or held at a lower potential. When a high voltage is applied to the source electrode, also referred to as the emitter electrode, it causes the air molecules around it to become ionized. This means that some of the air molecules lose or gain electrons, resulting in the formation of positively charged ions (cations) or negatively charged ions (anions). More particularly, the emitter electrode is charged with a high voltage (negative or positive), while the collector electrode is grounded or charged with an opposite voltage potential. Due to the electrostatic forces created by the electric field between the charged emitter and the grounded collector, the ions begin to move. Specifically, charged ions generated by the emitter electrode (either positive or negative) are repelled by the emitter and are drawn toward the oppositely charged collector electrode. As the anions move through the air, they collide with neutral air molecules. These collisions transfer momentum to the neutral molecules, setting them in motion. This process is known as ion-induced airflow or ionic wind. The movement of these neutral air molecules generates a macroscopic flow of air.

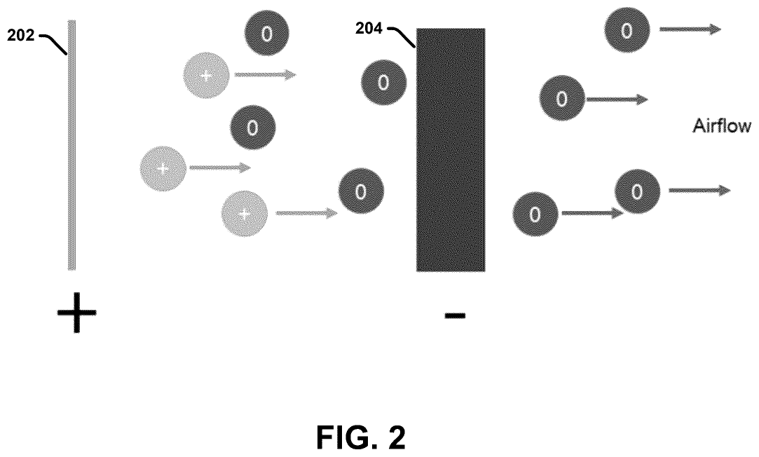

FIG. 2 illustrates the phenomenon of ionic wind in accordance with one or more embodiments of the disclosed subject matter. The process involves a high voltage emitter component 202 and a collector component 204. In this example, the emitter component 202 corresponds to a positively charged source and the collector component 204 corresponds to a negatively charged sink. However, it should be appreciated that in other embodiments, the voltage potentials of the emitter component 202 and the collector component 204 may be switched (e.g., the emitter component 202 can be negatively charged and the collector component 204 can be positively charged). In accordance with this example, based on application of a high, positive voltage electric current to the emitter component 202, air molecules around the positive source become ionized, creating positively charged particles (indicated via the circles with the plus+symbol). These positively charged particles or ions (i.e., cations) are attracted to and drawn toward the negatively collector component 204, leading to their movement toward the collector component 204. As the positively charged particles travel toward the collector component 204, they collide with the neutral air molecules (indicated via the circles with the zero indica) causing ionic wind airflow. In this regard, the charged particles essentially bump into and push the neutral air molecules in the direction toward the negatively charged collector component 204 and keep flowing in that direction past the negatively charged collector component 204, thereby creating airflow.

Since there are no moving parts involved, ionic wind modules operate silently. Traditional mechanical fans generate noise due to the rotation of blades and the resulting turbulence in the air. In contrast, EHD-based systems, including those employing ionic wind modules, are much quieter and do not generate any vibration.

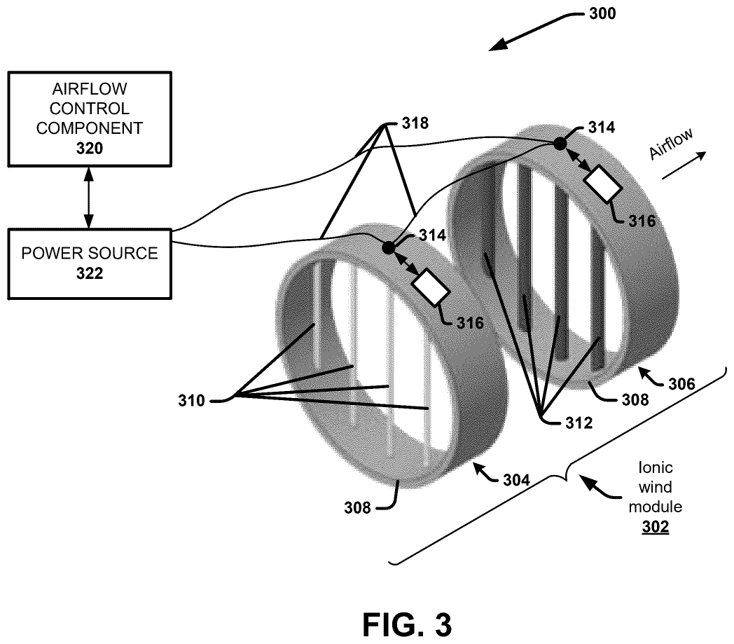

FIG. 3 presents an example ionic wind airflow system 300 in accordance with one or more embodiments of the disclosed subject matter. With reference to FIGS. 1-3, in various embodiments, the fan 106 and motor 122 can be removed from infant incubator 100 and replaced with ionic wind airflow system 300 and/or a similar ionic wind airflow system. The ionic wind airflow system 300 can comprise an ionic wind module, 302, a power source 322 and airflow control component 320. In various embodiments, the ionic wind airflow system 300 can include a plurality (e.g., two or more) of ionic wind modules corresponding to ionic wind module 302 and/or other variations thereof discussed infra. The ionic wind module 302 includes an emitter component 304 and a collector component 306. The emitter component 304 corresponds to the emitter component 202 illustrated in FIG. 2 and the collector component 306 corresponds to the collector component 204 illustrated in FIG. 2. In this regard, the emitter component 304 and the collector component 306 can respectively correspond to electrodes configured to be oppositely charged. For example, in some embodiments, the emitter component 304 can be configured to receive a positive voltage and generate cations while the collector component 306 can be negatively charged and/or grounded. With these embodiments, based on reception of an input electrical current from the power source 322 having a positive voltage, the emitter component 304 generates charged particles (i.e., cations) and the collector component 306 attracts the charged particles, wherein the charged particles collide with neutral air molecules while traveling toward the one collector component 306 causing the ionic wind airflow. In other embodiments, emitter component 304 can be configured to receive a negative voltage and generate anions while the collector component 306 can be positively charged and/or grounded. With these embodiments, based on reception of an input electrical current from the power source 322 having a negative voltage, the emitter component 304 generates charged particles (i.e., anions) and the collector component 306 attracts the charged particles, wherein the charged particles collide with neutral air molecules while traveling toward the one collector component 306 causing the ionic wind airflow.

The emitter component 304 includes a plurality of emitter electrodes 310 formed within a support frame 308. The collector component 306 similarly includes a plurality of collector electrodes 312 formed within another support frame 308. The emitter electrodes 310 and/or the collector electrodes 312 can be formed out of suitable conducting wires and/or tubes (e.g., conducting metal wires and/or tubes). The material employed for the support frame 308 can vary. For example, in some implementations, the support frame 308 may be formed out of one or more layers of insulative material and/or conductive material. In accordance with the embodiment shown in FIG. 3, the support frame 308 can have a circular geometry. However, the geometry of the support frame 308 is not limited to being circular and can vary. For example, in other embodiments, the geometry of the support frame 308 may be rectangular or another suitable geometry.

The emitter component 304 (and/or more specifically, the emitter electrodes 310 thereof) and the collector component 306 (and/or more specifically, the collector electrodes 312 thereof) are respectively electrically connected to the power source 322 via one or more wires 318 (and/or via another suitable electrical connection mechanism, such as via busbars, traces formed within a printed circuit board (PCB upon which the ionic wind module is mounted, or the like). For example, the emitter component 304 and the collector component 306 can respectively include input connection points 314 via which the one or more wires 318 can electrically connect the respective components and the electrodes thereof to the power source 322.

The power source 322 can include any suitable power source capable of supplying varying voltage levels of an electric current (e.g., a direct current (DC) to the ionic wind module 302 as controlled via the airflow control component 320. For example, the power source 322 preferably includes or corresponds to a power source capable of supplying a DC up to about 10 kilovolts (kv) or greater. For instance, the power source 322 can include a DC Boost step-up power module In some embodiments, the power source 322 can include one or more piezoelectric transformers.

To this end, based on application of a high voltage electric current (e.g., either positive or negative) to the emitter component 304 (or more specifically the emitter electrodes 310) as supplied via the power source 322, the emitter component 304 (or more specifically the emitter electrodes 310) generates charged particles (e.g., either positive or negative). Similarly based on simultaneous application of an opposing potential voltage (e.g., either positive or negative) to the collector component 306 (or more specifically the collector electrodes 312) as supplied via the power source 322, the collector component 306 (or more specifically the collector electrodes 312) generates oppositely charged particles. As described above with reference to FIG. 2, assuming the emitter component 304 receives a positive voltage and thus generates positive particles and the collector component 306 receives a negative voltage and thus generates negative particles. As the positively charged particles are dawn toward the negatively charged particles, they collide with neutral air molecules while traveling toward the collector component 306 and bump them in the direction toward and past the collector component 306, thereby creating ionic wind airflow in that direction.

In various embodiments, the amount of airflow (e.g., measured as a function of wind speed and/or total mass airflow) generated by an ionic wind module such as ionic wind module 302 and others described herein can be controlled and tailored based on the voltage amount or level applied to the emitter component 304 and/or the collector component 306 by the power source 322, wherein the amount of airflow generated coincides with the amount of voltage applied (e.g., the higher the voltage, the greater the airflow amount). In some embodiments, the power source 322 can be communicatively and/or operatively coupled to an airflow control component 320 that can control the amount of voltage applied to the emitter component 304 and the collector component 306 and thus the amount of airflow generated by the ionic wind module 302 (or similar ionic wind modules). For example, the airflow control component 320 can direct the power source 322 to apply a desired voltage level to generate a desired amount of airflow. The airflow control component 320 can further dynamically control increasing or decreasing the amount of airflow generated by directing the power source 322 to increase or decrease the voltage level. The airflow control component 320 can further control turning the ionic wind module 302 on and off (and thus the timing of airflow generation or lack thereof) based on directing the power source 322 to either supply or not supply the electric current.

In some embodiments, each of the emitter electrodes 310 can be electrically connected to one another (e.g., via wired connections formed on or within the corresponding support frame 308) in parallel such that each of the emitter electrodes 310 receive power at the same time. Likewise, each of the collector electrodes 312 can be electrically connected to one another (e.g., via wired connections formed on or within the corresponding support frame 308) in parallel such that each of the collector electrodes 312 receive power at the same time. Additionally, or alternatively, the supply of power from the power source 322 to each of the emitter electrodes 310 and/or each of the collector electrodes 312 can be independently controlled. With these embodiments, the ionic wind system 300 can selectively activate or deactivate individual ones of the emitter electrodes 310 and/or the collector electrodes 312 to increase or decrease the amount of airflow. For example, in some embodiments, each of the emitter electrodes 310 and/or each of the collector electrodes 312 can separately connected to the power source 322 via separate wires, respectively creating independent power channels to each of the electrodes which can be independently controlled via the airflow control component 320. In other embodiments, the emitter component 304 and/or the collector component 306 can include power switches integrated on or within the support frame 308 (e.g., diodes, field effect transistors (FETs), metal oxide field effect transistors (MOFETs) that control switching on and/off power supply to the individual electrodes as received from the input connection points 314. In some implementations of these embodiments, the emitter component 304 and/or the collector component 306 can respectively include a local controller 316 that controls activation and deactivation of the respective power switches. For example, the local controller 316 can include or correspond to microchip or the like comprising memory and processing functionality and corresponding logic configured to control activation and deactivation of the respective power switches.

The amount of airflow can also be controlled and tailored as a function of the design of the ionic wind module 302, including the geometry and size of the respective electrodes and the support frame 308, the number of emitter electrodes 310 and collector electrodes 312, the size and spacing between the electrodes, the material of the electrodes, and the spacing between the emitter component 304 and the collector component 306. In some embodiments, the emitter component 304 and the collector component 306 can be mechanically adjusted and controlled (e.g., via the airflow control component 320) using actuators or the like that are operatively coupled to the respective components. With these embodiments, the airflow control component 320 can dynamically adjust the spacing to vary the amount of airflow generated.

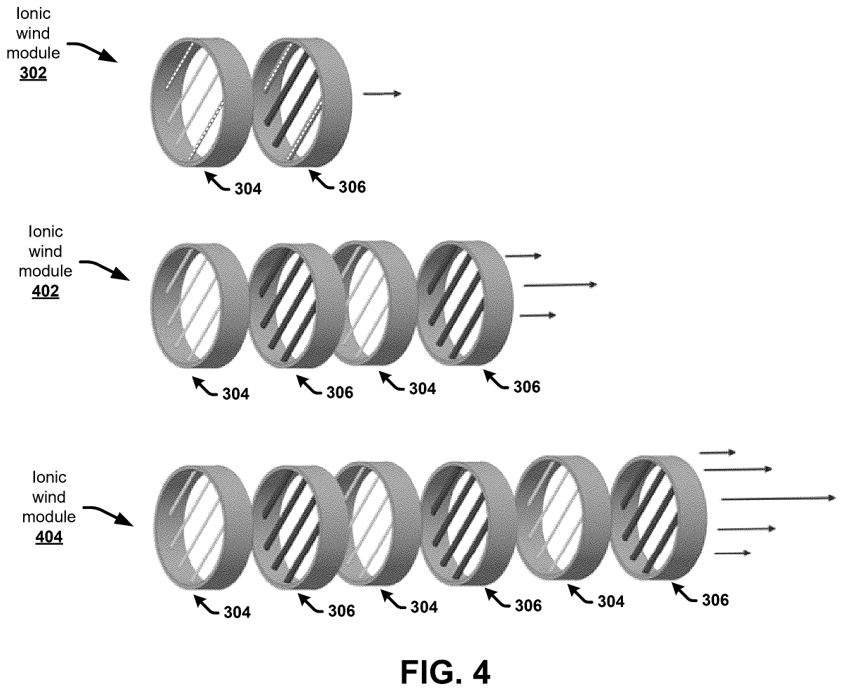

In addition, the amount of airflow can be increased by stacking multiple alternating emitter components (corresponding to emitter component 304) and collector components (corresponding to collector component 304) together in an alternating fashion, as illustrated in FIG. 4.

In this regard, FIG. 4 presents different ionic airflow module configurations for generating varying amounts of total mass airflow, in accordance with one or more embodiments of the disclosed subject matter. With reference to FIGS. 1-4, the different configurations respectively employ one or more emitter components 304 and one or more collector components 306. Although some elements and reference numerals have been removed for sake of brevity, is to be appreciated that the features and functionalities of the respective components can include any of those discussed above with reference to FIG. 3. Likewise, it should be appreciated that the respective components can be connected to the power source 322 (or another power source) and the airflow control component 320 in accordance with techniques described above with reference to FIG. 3.

The topmost configuration shown in FIG. 4 illustrates ionic wind module 302 in accordance with an embodiment in which only subset of the emitter electrodes 310 and the collector electrodes 312 are activated. For example, the dashed white lines are used to indicate the corresponding electrodes are not currently activated. To this end, in some embodiments, one or more of the emitter electrodes 310 and/or the collector electrodes 312 can be selectively activated and deactivated by the airflow control component 320 to increase and decrease the total amount of airflow generated.

The middle configuration and the lower configuration shown in FIG. 4 illustrate stacking of a plurality of alternating emitter components 304 and collector components 306 to generate increased airflow, wherein the greater number of alternating pairs of emitter components 304 and collector components 306, the greater the amount of airflow capable of being generated. For example, the middle configuration illustrates an example ionic wind module 402 comprising two emitter components 304 and two collector components 306 arranged in an alternating fashion. The lower configuration illustrates another example ionic wind module 404 comprising three emitter components 304 and three collector components 306 arranged in an alternating fashion. As indicated by the amount of arrowed lines illustrated with respect to the different configurations (which correspond to the amount of airflow), as the number of alternative positive and collector components is increased, the amount of airflow capable of being generated is also increased.

In various embodiments, infant incubator 100 and/or other similar enclosed infant incubators can incorporate an ionic wind airflow system corresponding to ionic wind airflow system 300 (and/or variations thereof) to generate an ionic wind airflow within the chamber 102 (or a similar chamber) without usage of a motorized fan, thereby eliminating the noise and vibration caused by the motorized fan. The ionic wind airflow system can include one or more ionic wind modules corresponding to ionic wind module 302, ionic wind module 402, ionic wind module 404 and/or variants thereof.

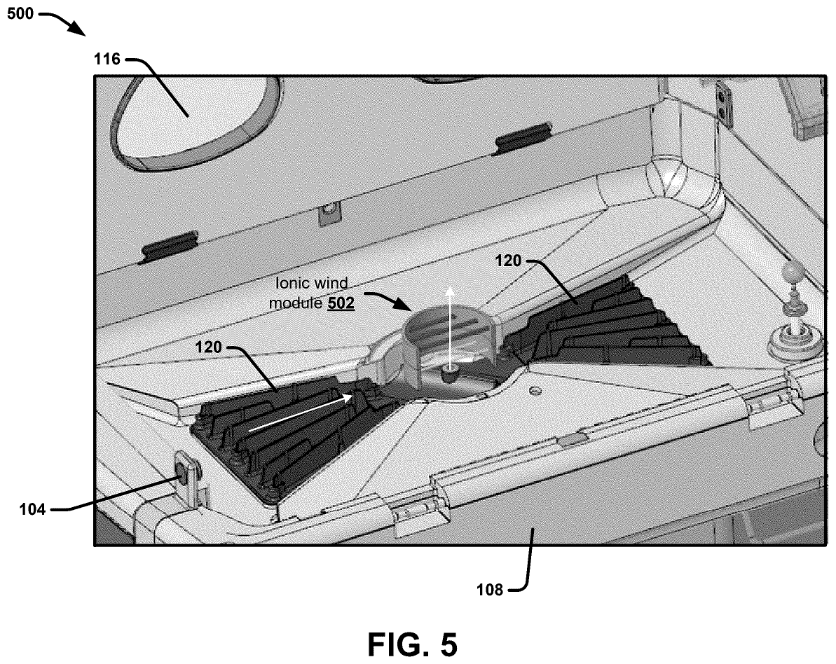

FIG. 5 illustrates an enlarged view of a portion of an example infant incubator 500 incorporating an ionic wind airflow system in accordance with one or more embodiments of the disclosed subject matter. With reference to FIGS. 1-5, in various embodiments, infant incubator 500 corresponds to infant incubator 100 with the fan 106 and motor 122 removed and replaced with an ionic wind module 502. To this end, ionic wind module 502 can correspond to ionic wind module 302, ionic wind module 402, ionic wind module 404, and/or variants thereof. Although not shown, it should be appreciated that the ionic wind module 502 can be electrically and operatively connected to the power source 322 and the airflow control component 320 in accordance with the techniques described with reference to FIG. 3. The particular location of the power source 322 and the airflow control component 320 relative to the infant incubator 500 can vary. For example, in some implementations, the power source 322 and/or the airflow control component 320 may be physically and/or logically integrated on or within the support structure 108, the back panel 122 and/or another region of the infant incubator 500.

In accordance with this embodiment, the fan 106 can be directly replaced with an ionic wind module 502 such that the ionic wind module 502 pulls and inflow air current from at least one inflow opening (e.g., opening 104) across the heating element 120 in association with generating an ionic wind flow directed toward the interior of the chamber 102. To this end, the ionic wind module 502 can be integrated on or within the platform structure 108 at a position corresponding to the position of the fan 106. For example, the ionic wind module 502 can be integrated on or within the heating element 120, between portions of the heating element 120, or the like, such that the ionic wind module 502 draws air over the heating element 120, generates warmed or heated air and directs the warmed or heated air into the interior of the chamber 102.

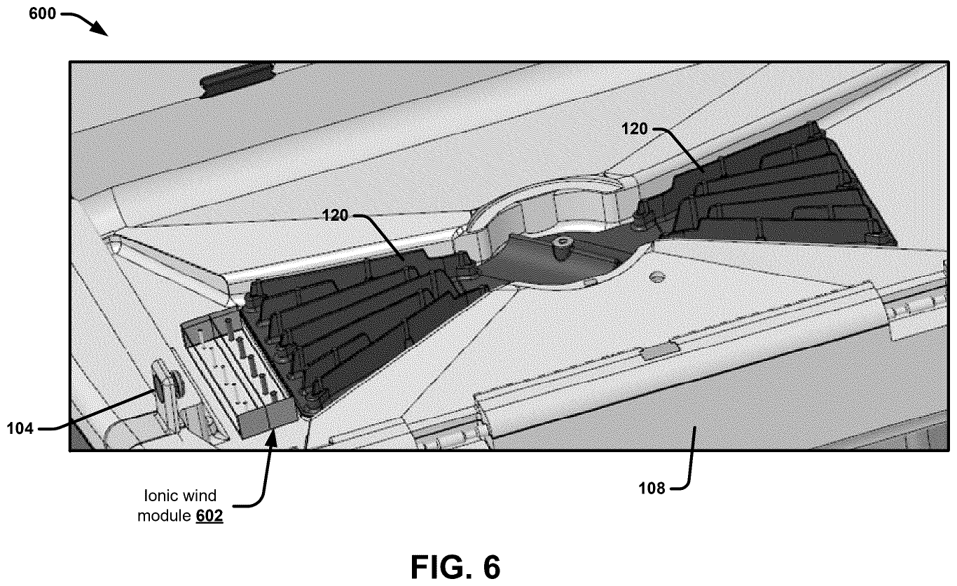

FIG. 6 illustrates an enlarged view of a portion of another example infant incubator 600 incorporating an ionic wind airflow system in accordance with one or more embodiments of the disclosed subject matter. With reference to FIGS. 1-6, in various embodiments, infant incubator 600 corresponds to infant incubator 100 with the fan 106 and motor 122 removed and replaced with an ionic wind module 602. Although not shown, it should be appreciated that the ionic wind module 602 can be electrically and operatively connected to the power source 322 and the airflow control component 320 in accordance with the techniques described with reference to FIG. 3. The particular location of the power source 322 and the airflow control component 320 relative to the infant incubator 600 can vary. For example, in some implementations, the power source 322 and/or the airflow control component 320 may be physically and/or logically integrated on or within the support structure 108, the back panel 122 and/or another region of the infant incubator 600.

In accordance with this embodiment, the emitter and collector components respectively employ a rectangular geometry as opposed to a circular geometry. However, as noted above, the geometry, size, number of alternating emitter and collector components, and other parameters of the ionic wind module 602 can vary. To this end, ionic wind module 602 can correspond to ionic wind module 302, ionic wind module 402, ionic wind module 404, ionic wind module 502 and/or variants thereof. In accordance with this embodiment, the fan 106 and motor 122 can be removed from infant incubator 100 and replaced with an ionic wind module 602 positioned on or within the platform structure 108 between the inlet opening 104 and the heating element 120. With this embodiment, the ionic wind module 602 can pull inflow air current from at least one inflow opening (e.g., opening 104) and blow or direct ionic wind airflow across the heating element 120 in association with generating an ionic wind flow directed toward the interior of the chamber 102. In other words, the ionic wind module 602 can be integrated within the infant incubator 100 relative to the heating element 120 such that the ionic wind module 602 pushes or blows ionic wind over and across the heating element 120.

FIG. 7 illustrates an enlarged view of a portion of another example infant incubator 700 incorporating an ionic wind airflow system in accordance with one or more embodiments of the disclosed subject matter. With reference to FIGS. 1-7, in various embodiments, infant incubator 700 corresponds to infant incubator 100 with the fan 106 and motor 122 removed and replaced with an ionic wind module 702. Although not shown, it should be appreciated that the ionic wind module 702 can be electrically and operatively connected to the power source 322 and the airflow control component 320 in accordance with the techniques described with reference to FIG. 3. The particular location of the power source 322 and the airflow control component 320 relative to the infant incubator 700 can vary. For example, in some implementations, the power source 322 and/or the airflow control component 320 may be physically and/or logically integrated on or within the support structure 108, the back panel 122 and/or another region of the infant incubator 600.

In accordance with this embodiment, the emitter and collector components respectively employ a rectangular geometry as opposed to a circular geometry. However, as noted above, the geometry, size, number of alternating emitter and collector components, and other parameters of the ionic wind module 702 can vary. To this end, ionic wind module 702 can correspond to ionic wind module 302, ionic wind module 402, ionic wind module 404, ionic wind module 502, ionic wind module 702 and/or variants thereof. In accordance with this embodiment, the fan 106 and motor 122 can be removed from the infant incubator 100 and replaced with an ionic wind module 702 positioned on or within the platform structure 108 at position where the platform structure 108 connects to the double walled doors such that the ionic wind module 702 draws air over the heating element and directs the heated air through the open region 704 between the double walled doors and into the interior of the chamber 102. In this regard, as described with reference to FIG. 1A, in some embodiments, the sidewall comprising the portholes 116 corresponds to double walled doors formed via exterior door 118a and interior door 118b. These double walled doors respectively correspond to parallel panels separated from one another via an open region 704 and provide at least one airflow opening from the open region 704 into the interior of chamber (e.g., formed through the interior door 118, along the top edge of the interior door 118b, and/or another location). With this embodiment, the ionic wind module 702 can be positioned at the intersection between the base of the platform structure 108 and the interior door 118b such that the ionic wind module 702 generates an ionic wind through the open region 704 between the double walled doors, pulling air heated by the heating element 120 therethrough, and directs the heated air into the interior of the chamber 102, as indicated by the airflow pattern represented by the arrowed lines.

It should be appreciated that the different ionic wind module configurations illustrated in FIGS. 5, 6 and 7 are merely some examples of suitable positions for integrating ionic wind modules within infant incubator 100 with the fan 106 and motor 122 removed, and that various other configurations are envisioned. To this end, the number of distinct ionic wind modules incorporated into the ionic wind airflow system employed by an enclosed infant incubator corresponding to infant incubator 100 with the fan 106 and motor 122 removed can vary and be tailored to create any desired airflow pattern of ionic wind airflow within and throughout the chamber 102. For example, in some embodiments, the infant incubator 100 can include a combination of two or more of the different ionic wind module configurations illustrated in FIGS. 5, 6 and 7. In this regard, an infant incubator corresponding to infant incubator 100 with the fan and motor removed can employ an airflow system that comprises a plurality of different ionic wind modules distributed at different positions relative to the chamber 102.

In addition, the number of different ionic wind modules and the relative positions of the different ionic wind modules as distributed throughout the infant incubator 100 with the fan and motor removed can also be tailored to create any desired airflow pattern of ionic wind airflow within and throughout the chamber 102. The different ionic wind modules can also be the same or vary with respect to amount of airflow cable of being generated thereby as a function of the number of alternating emitter components 304 and collector component 306, the geometry and spacing of the emitter components 304 and the collector components 306, the number of emitter electrodes 310 and collector electrodes 312, the material, geometry and spacing of the respective electrodes, and so on.

It should be appreciated that in embodiments in which a plurality (e.g., two or more) different icon wind modules are incorporated into the infant incubator, that each of the different ionic wind modules can be connected to the power source 322 and the airflow control component 320. In some embodiments, each of the one or more icon wind modules incorporated into the infant incubator 100 (or a similar enclosed infant incubator with the fan 106 and motor 122 removed) can be independently controlled by the airflow control component 320 to generate varying amounts of airflow and/or varying airflow patterns. For example, the airflow control component 320 can independently control turning on and off individual ones of the ionic airflow modules to control the timing and amount of airflow collectively generated by the ionic wind airflow system as needed to maintain a desired airflow pattern, airflow rate, temperature, humidity level, etc. as needed based on monitored values for the respective parameters (e.g., as measured continuously via one more sensors 824) and defined optimization criteria for the respective parameters. The airflow control component 320 can also independently control the amount of airflow generated by individual ones of the ionic airflow modules by varying the voltage level of the input electrical current and/or by independently controlling activation and deactivation of individual ones of the emitter electrodes 310 and/or the collector electrodes 312. In some embodiments, the airflow control component 320 can also independently control the amount of airflow generated by individual ones of the ionic airflow modules by adjusting (e.g., via any suitable mechanical actuator mechanisms) the relative positions or spacing between the emitter component 304 and the collector component 306).

FIG. 8 illustrates a block diagram of an example infant incubator 800 incorporating an ionic wind airflow system 822 in accordance with one or more embodiments of the disclosed subject matter. With reference to FIGS. 1-8, in various embodiments, infant incubator 800 corresponds to infant incubator 100 (or a similar enclosed infant incubator) with the fan 106 and motor 122 removed and replaced with ionic wind airflow system 822. For example, infant incubator 800 can correspond to infant incubator 500, infant incubator 600, infant incubator 700 and/or variants thereof. In this regard, infant incubator 800 can include a chamber 102 adapted to enclose or partially enclose an infant placed therein. Infant incubator 800 can further include (but is not limited to), computing system 802, ionic wind airflow system 822, power source 322, one or more sensors 824, and heating element 120. In various embodiments, the computing system 802, the ionic wind airflow system 822, the power source 322, the one or more sensors 824 and the heating element 120 can be electrically and/or communicatively coupled to one another via at least one bus 820. Repetitive description of like elements employed in respective embodiments is omitted for sake of brevity.

The ionic wind airflow system 822 can include or correspond to ionic wind airflow system 300 or variants thereof. In this regard, ionic wind airflow system 822 can include one or more ionic wind modules integrated on or within the infant incubator 800 that generate an ionic wind airflow within the chamber 102 in accordance with the example embodiments illustrated in FIGS. 5-7, or variations thereof. The one or more ionic wind modules can include or correspond to ionic wind module 302, ionic wind module 402, ionic wind module 404, ionic wind module 502, ionic wind module 602, ionic wind module 702, and/or variants thereof. Each of the one or more ionic wind modules can be electrically connected (e.g., via bus 820) to power source 322 in accordance with the techniques discussed above with reference to FIG. 3.

In some embodiments, at least one module of the one or more ionic wind modules of the ionic wind airflow system 822 pulls an inflow air current across the heating element 120 in association with generating at least a portion of the ionic wind airflow within the chamber 102 (e.g., in accordance with the embodiment illustrated in FIG. 5). Additionally, or alternatively, at least one module of the one or more ionic wind modules of the ionic wind airflow system 822 directs at least a portion of the ionic wind airflow across the heating element 122 (e.g., in accordance with the embodiment illustrated in FIG. 6). Additionally, or alternatively, the chamber 102 can comprise a sidewall comprising parallel panels separated from one another via an open region (e.g., open region 704), and at least one airflow opening from the open region into the chamber (e.g., portholes 116 and/or another opening), and wherein at least one module of the one or more ionic wind modules of the ionic wind airflow system 822 directs at least a portion of the ionic wind airflow into the open region and through the at least one airflow opening (e.g., in accordance with the embodiment illustrated in FIG. 7). To this end, the number of different ionic wind modules of the ionic wind airflow system 822, the positions of the different icon wind modules as integrated relative to the chamber 102, the number of alternative emitter components 304 and collector components 306, the geometry, spacing and material of the emitter and collector components, and so on, can vary and be tailored to create any desired ionic wind flow pattern within the chamber 102.

The one or more sensors 824 can include or corresponds to one or more sensors integrated on and/or within the chamber 102 adapted to measure one or more environmental parameters of the chamber 102 (e.g., continuously and/or regularly). For example, the one or more sensors 824 can include one or more sensors configured to measure an amount of airflow generated by respective ones of the ionic wind modules (e.g., measured as a function of speed, volume in cubic feet per minute, or another suitable metric), temperature, humidity level, oxygen level, and/or various other relevant environmental parameters.

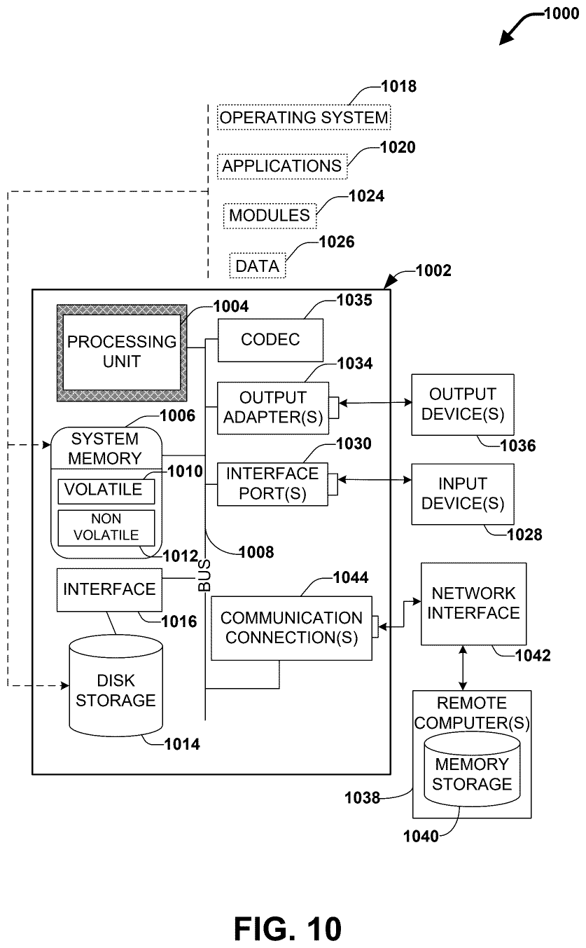

The computing system 802 can include or correspond to any suitable computing device, machine, or the like that can include ore be operatively coupled to at least one memory 812 that stores machine-executable or computer-executable components or instructions embodied within one or more machines (e.g., embodied in one or more computer-readable storage media associated with one or more machines), and at least one processing unit 814 that executes the computer-executable components stored in the at least one memory 812. These computer-executable components can include (but are not limited to) airflow control component 320, monitoring component 806 and artificial intelligence component 808. The computing system 802 can also include communication component 816 and one or more input/output devices 818. Communication component 816 can include or correspond to suitable hardware and/or software that enables wired and/or wireless communication between the computing system and other systems and/or devices using any suitable wired and/or wireless communication technology. The one or more input/output device 818 can include any suitable input and/or output devices that facilitate receiving user input and/or rendering data to users in association with usage of infant incubator 800. Suitable example of said and memory 812, processing unit 814, communication component 816, input/output devices 818, well as other suitable computer or computing-based elements, can be found with reference to FIG. 10 (e.g., processing unit 1004 and system memory 1006 respectively), and can be used in connection with implementing one or more of the systems or components shown and described in connection with FIG. 8, or other figures disclosed herein. Computing system 802 can also include a system bus 810 that couples the memory 812, the processing unit 814, the communication component 816 and the input/output devices 818 to one another.

As noted above, in various embodiments, the airflow control component 320 can control one or more operations of the ionic wind airflow system 822. For example, the airflow control component 320 can control provision (or lack thereof) of an input electric current to respective ionic wind modules of the ionic wind airflow system 822 from the power source 322, including timing of provision and amount of electrical current provided. Accordingly, the airflow control component 320 can control timing of provision of input electrical current (and thus timing of airflow generation) and the voltage level of the input electrical current (and thus the amount of airflow generation). In some embodiments, the airflow control component 320 can also selectively and independently control the number of individual electrons activated or deactivated (e.g., emitter electrodes 310 and/or collector electrodes 312) and thus the amount of airflow generated by the corresponding ionic wind module. In some implementations in which the emitter components 304 and/or the collector components 306 are mechanically adjustable (e.g., via respective actuators coupled thereto or the like), the airflow control component 320 can also control the spacing and/or orientation of the respective components and thus the corresponding direction and/or amount of airflow generated.

To this end, by adjusting the timing and/or amount of airflow generation by respective ones of the ionic wind flow modules, the airflow control component 320 can control and regulate airflow withing the chamber 102 over the course of operation of the infant incubator 800. In addition, in implementations in which the infant incubator includes two or more distinct ionic wind modules located at different positions relative to the chamber 102, the airflow control component 320 can selectively activate and deactivate different ones of the ionic wind modules to control and adjust the airflow pattern within the chamber.

In various embodiments, the airflow control component 320 can dynamically control and adjust the airflow pattern and amount of airflow generated by respective ones of the ionic wind modules based on the monitored environmental state of the chamber and optimal or preferred values of one or more monitored environmental parameters (e.g., as measured via the one or more sensors 824 and monitored and/or received via the monitoring component 806). For example, the monitoring component 806 can receive and monitor various environmental parameters of the chamber 102 over course of operation thereof, as measured via the one or more sensors 824, including but not limited to, airflow generation amount, airflow direction, airflow pattern, temperature, humidity, and oxygen level. The airflow control component 320 can further dynamically adjust the timing of activation/deactivation of individual ionic wind modules, the amount of airflow generated (e.g., by varying the input electrical current voltage amount and/or using another mechanism disclosed herein), and the airflow pattern accordingly based on optimization criteria for the timing of airflow generation, the amount of airflow generated and the airflow pattern.

In various embodiments, the optimization criteria can control the timing of airflow generated, the amount of airflow generated, and/or the airflow pattern as a function of temperature, humidity level, oxygen level and/or other contextual parameters associated with the operation of the infant incubator 100. In this regard, by controlling the airflow distribution pattern, amount and timing, the airflow control component can control and/or regulate temperature distribution (e.g., circulating air heated by the heating element 120), minimize temperature variations, control humidity distribution, control condensation, and control oxygen distribution. In some embodiments, the airflow control component 320 can employ predefined optimization criteria (e.g., stored in memory 812) for respective environmental parameter values and dynamically adjust the amount of airflow generated by respective ones of the ionic wind modules in accordance with predefined control settings to create and maintain the optimal environmental parameter values. It should be appreciated that the optimal environmental parameter values can vary depending on the needs and health condition of the infant and the usage context of the infant incubator 800 (e.g., with respect to whether the incubator is in a closed state, an open state with one or more doors/windows open, a partially closed state, or the like). In this regard, in some embodiments, the optimal environmental parameter values can account for various other dynamic variables, including but not limited to, monitored parameters of the infant (e.g., vital signs, activity levels, sleep patterns, stress level, fatigue level, mood, physical position), contextual parameters (e.g., time of day, usage context of the incubator, etc.), the health condition/state of the infant, medical history of the infant, and so on.

Additionally, or alternatively, the computing system 802 can employ artificial intelligence to facilitate inferring how and when to adjust the airflow amount and/or pattern as generated by respective ionic wind modules of the ionic wind airflow system 822 over the course of operation of the infant incubator 800. To facilitate this end, the computing system 802 can include artificial intelligence component 808 that can employ artificial intelligence to facilitate automating one or more features or functionalities of the airflow control component 320 based on monitored environmental parameters of the chamber 102, monitored parameters of the infant, and other factors. The artificial intelligence component 808 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, the artificial intelligence component 808 can examine the entirety or a subset of the data to which it is granted access and can provide for reasoning about or determine states of the infant incubator 800, the environment within the chamber 102 and the infant from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z1, z2, z3, z4, zn), to a confidence that the input belongs to a class, as by f (2)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

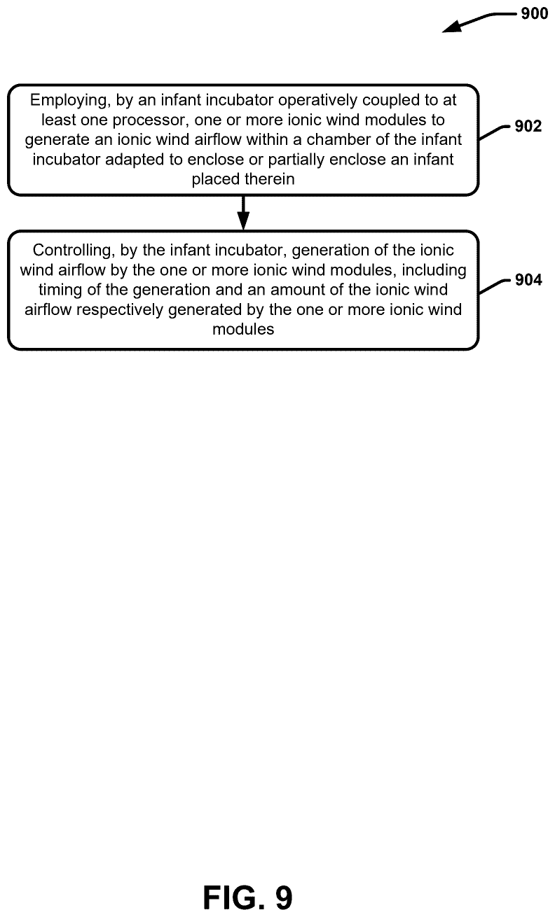

FIG. 9 illustrates a block diagram of an example, non-limiting computer implemented method 900 that facilitates creating a stable environment within an infant incubator using an ionic wind airflow system, in accordance with one or more embodiments of the disclosed subject matter. Method 900 corresponds to an example method that can be performed by an infant incubator corresponding to infant incubator 500, infant incubator 600, infant incubator 700, infant incubator 800 and/or other variations thereof. In accordance with method 900, at 902, an infant incubator operatively coupled to at least one processor (e.g., processing unit 814) employs one or more ionic wind modules to generate an ionic wind airflow within a chamber (e.g., chamber 102) of the infant incubator adapted to enclose or partially enclose an infant placed therein. For example, the one or more ionic wind modules can include or correspond to ionic wind module 302, ionic wind module 402, ionic wind module 404, ionic wind module 502, ionic wind module 602, ionic wind module 702 and/or variations thereof. At 904, method 900 comprises controlling, by the infant incubator (e.g., via airflow control component 320), generation of the ionic wind airflow by the one or more ionic wind modules, including timing of the generation and an amount of the ionic wind airflow respectively generated by the one or more ionic wind modules. For example, the airflow control component 320 can control the timing and amount of airflow generated by respective ones of the one or more ionic wind modules based on controlling provision (and non-provision) of an input electrical current (e.g., supplied via power source 320) to respective ones of the one or more ionic wind modules and a voltage level of the input electrical current.

In some embodiments in which the infant incubator comprises a plurality of the ionic wind modules, the airflow control component 320 can control each of the ionic wind modules independently. For example, the airflow control component can selectively activate and deactivate (e.g., turn on and off) each of the ionic wind modules independently 320 and selectively increase or decrease the amount of airflow respectively generated by each of the ionic wind modules independently. In this manner, the airflow control component 320 can dynamically adjust and regulate the total amount of airflow generated within the chamber to maintain a stable environment withing the chamber 102. In this manner, the airflow control component 320 can also dynamically adjust the airflow pattern within the chamber 102.

In this regard, the airflow control component 320 can regulate one or more environmental parameters of the chamber 102 over a duration of operation of the infant incubator based on controlling the timing of activation and deactivation of respective ones of the ionic wind modules, the amount of airflow generated, and the airflow pattern, wherein the one or more environmental parameters can include, but are not limited to, a temperature within the chamber, a humidity level within the chamber, and an oxygen level within the chamber. For example, in some embodiments, method 900 can further comprise regulating, by the infant incubator, one or more environmental parameters of the chamber over a duration of operation of the infant incubator based on the controlling at 904, the one or more environmental parameters selected from the group consisting of: a temperature within the chamber, a humidity level within the chamber, and an oxygen level within the chamber. To facilitate this end, the infant incubator can monitor (e.g., via monitoring component 806) respective values of the one or more environmental parameters over the duration of operation of the infant incubator as measured via one or more sensors, and dynamically adjust the timing of activation and deactivation of respective ones of the ionic wind modules, the amount of airflow generated, and/or the airflow pattern amount based on optimization criteria for respective values of the environmental parameters.

### Example Operating Environments

One or more embodiments can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. To this end, the a computer readable storage medium, a machine-readable storage medium, or the like as used herein can include a non-transitory computer readable storage medium, a non-transitory machine-readable storage medium, and the like.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In connection with FIG. 10, the systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which can be explicitly illustrated herein.

With reference to FIG. 10, an example environment 1000 for implementing various aspects of the claimed subject matter includes a computer 1002. The computer 1002 includes a processing unit 1004, a system memory 1006, a codec 1035, and a system bus 1008. The system bus 1008 couples system components including, but not limited to, the system memory 1006 to the processing unit 1004. The processing unit 1004 can be any of various available processors. Dual microprocessors and other multiprocessor architectures also can be employed as the processing unit 1004.

The system bus 1008 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13104), and Small Computer Systems Interface (SCSI).

The system memory 1006 includes volatile memory 1010 and non-volatile memory 1012, which can employ one or more of the disclosed memory architectures, in various embodiments. The basic input/output system (BIOS), containing the basic routines to transfer information between elements within the computer 1002, such as during start-up, is stored in non-volatile memory 1012. In addition, according to present innovations, codec 1035 can include at least one of an encoder or decoder, wherein the at least one of an encoder or decoder can consist of hardware, software, or a combination of hardware and software. Although, codec 1035 is depicted as a separate component, codec 1035 can be contained within non-volatile memory 1012. By way of illustration, and not limitation, non-volatile memory 1012 can include read only memory (ROM), programmable ROM (PROM), electrically programmable ROM (EPROM), electrically erasable programmable ROM (EEPROM), Flash memory, 3D Flash memory, or resistive memory such as resistive random access memory (RRAM). Non-volatile memory 1012 can employ one or more of the disclosed memory devices, in at least some embodiments. Moreover, non-volatile memory 1012 can be computer memory (e.g., physically integrated with computer 1002 or a mainboard thereof), or removable memory. Examples of suitable removable memory with which disclosed embodiments can be implemented can include a secure digital (SD) card, a compact Flash (CF) card, a universal serial bus (USB) memory stick, or the like. Volatile memory 1010 includes random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 1002 can also include removable/non-removable, volatile/non-volatile computer storage medium. FIG. 10 illustrates, for example, disk storage 1014. Disk storage 1014 includes, but is not limited to, devices like a magnetic disk drive, solid state disk (SSD), flash memory card, or memory stick. In addition, disk storage 1014 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1014 to the system bus 1008, a removable or non-removable interface is typically used, such as interface 1016. It is appreciated that disk storage 1014 can store information related to a user. Such information might be stored at or provided to a server or to an application running on a user device. In one embodiment, the user can be notified (e.g., by way of output device(s) 1036) of the types of information that are stored to disk storage 1014 or transmitted to the server or application. The user can be provided the opportunity to opt-in or opt-out of having such information collected or shared with the server or application (e.g., by way of input from input device(s) 1028).

It is to be appreciated that FIG. 10 describes software that acts as an intermediary between users and the basic computer resources described in the suitable operating environment 1000. Such software includes an operating system 1010. Operating system 1010, which can be stored on disk storage 1014, acts to control and allocate resources of the computer 1002. Applications 1020 take advantage of the management of resources by operating system 1010 through program modules 1024, and program data 1026, such as the boot/shutdown transaction table and the like, stored either in system memory 1006 or on disk storage 1014. It is to be appreciated that the claimed subject matter can be implemented with various operating systems or combinations of operating systems.

A user enters commands or information into the computer 1002 through input device(s) 1028. Input devices 1028 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1004 through the system bus 1008 via interface port(s) 1030. Interface port(s) 1030 include, for example, a serial port, a parallel port, a game port, and a universal serial bus (USB). Output device(s) 1036 use some of the same type of ports as input device(s) 1028. Thus, for example, a USB port can be used to provide input to computer 1002 and to output information from computer 1002 to an output device 1036. Output adapter 1034 is provided to illustrate that there are some output devices 1036 like monitors, speakers, and printers, among other output devices 1036, which require special adapters. The output adapters 1034 include, by way of illustration and not limitation, video and sound cards that provide a means of connection between the output device 1036 and the system bus 1008. It should be noted that other devices or systems of devices provide both input and output capabilities such as remote computer(s) 1038.

Computer 1002 can operate in a networked environment using logical connections to one or more remote computers, such as remote computer(s) 1038. The remote computer(s) 1038 can be a personal computer, a server, a router, a network PC, a workstation, a microprocessor based appliance, a peer device, a smart phone, a tablet, or other network node, and typically includes many of the elements described relative to computer 1002. For purposes of brevity, only a memory storage device 1040 is illustrated with remote computer(s) 1038. Remote computer(s) 1038 is logically connected to computer 1002 through a network interface 1042 and then connected via communication connection(s) 1044. Network interface 1042 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1044 refers to the hardware/software employed to connect the network interface 1042 to the bus 1008. While communication connection 1044 is shown for illustrative clarity inside computer 1002, it can also be external to computer 1002. The hardware/software necessary for connection to the network interface 1042 includes, for exemplary purposes only, internal and external technologies such as, modems including regular telephone grade modems, cable modems and DSL modems, ISDN adapters, and wired and wireless Ethernet cards, hubs, and routers.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components, as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. An infant incubator, comprising:
a chamber adapted to enclose or partially enclose an infant placed therein; and
an airflow system, comprising:
one or more ionic wind modules that generate an ionic wind airflow within the chamber.

2. The infant incubator of claim 1, wherein the one or more ionic wind modules generate the ionic wind airflow without generation of acoustic noise or vibration.

3. The infant incubator of claim 1, wherein the airflow system comprises a plurality of the ionic wind modules distributed at different positions relative to the chamber.

4. The infant incubator of claim 1, further comprising:
a heating element that provides a controlled source of heat within the chamber, wherein at least one module of the one or more ionic wind modules pulls an inflow air current across the heating element in association with generating at least a portion of the ionic wind airflow.

5. The infant incubator of claim 1, further comprising:
a heating element that provides a controlled source of heat into the chamber, wherein at least one module of the one or more ionic wind modules directs at least a portion of the ionic wind airflow across the heating element.

6. The infant incubator of claim 1, wherein the chamber comprises a sidewall comprising parallel panels separated from one another via an open region, and at least one airflow opening from the open region into the chamber, and wherein at least one module of the one or more ionic wind modules directs at least a portion of the ionic wind airflow into the open region and through the at least one airflow opening.

7. The infant incubator of claim 1, wherein each of the one or more ionic wind modules comprises:
one or more emitter components and one or more collector components respectively connected to a power source, wherein based on reception of an input electrical current from the power source, the one or more emitter components generate charged particles and the one or more collector components attract the charged particles, and wherein the charged particles collide with neutral air molecules while traveling toward the one or more collector components causing the ionic wind airflow.

8. The infant incubator claim 7, wherein at least one of the one or more ionic wind modules comprises two or more of the emitter components and two or more of the collector components arranged in alternating stages, and wherein an amount of the ionic wind airflow respectively generated by the one or more ionic wind modules varies as a function of a voltage level of the input electrical current, a number of the emitter components and the collector components, and spacing between the emitter components and the collector components.

9. The infant incubator of claim 7, further comprising a memory that stores computer-executable components and a processor that executes the computer-executable components, wherein the computer-executable components comprise:
an airflow control component that controls generation of the ionic wind airflow by the one or more ionic wind modules, including timing of the generation and an amount of the ionic wind airflow respectively generated by the one or more ionic wind modules based on controlling provision of the input electrical current and a voltage level of the input electrical current.

10. The system of claim 9, wherein the airflow system comprises a plurality of the ionic wind modules distributed at different positions relative to the chamber, and wherein each of the ionic wind modules are independently controlled by the airflow control component.

11. The system of claim 9, wherein the computer-executable components comprise:
a monitoring component that tracks environmental parameters of the chamber over a duration of operation of the infant incubator, including the amount of the ionic wind airflow respectively generated by the one or more ionic wind modules, a temperature within the chamber, a humidity level within the chamber, and an oxygen level within the chamber, and wherein the airflow control component dynamically adjusts the amount based on optimization criteria for respective values of the environmental parameters.

12. A method, comprising:
employing, by an infant incubator operatively coupled to at least one processor, one or more ionic wind modules to generate an ionic wind airflow within a chamber of the infant incubator adapted to enclose or partially enclose an infant placed therein.

13. The method of claim 12, further comprising:
controlling, by the infant incubator, generation of the ionic wind airflow by the one or more ionic wind modules, including timing of the generation and an amount of the ionic wind airflow respectively generated by the one or more ionic wind modules.

14. The method of claim 13, wherein the controlling comprises controlling the amount of the ionic wind airflow based on controlling provision of an input electrical current to respective ones of the one or more ionic wind modules and a voltage level of the input electrical current.

15. The method of claim 13, wherein the infant incubator comprises a plurality of the ionic wind modules and wherein the controlling comprises controlling each of the ionic wind modules independently.

16. The method of claim 13, further comprising:
regulating, by the infant incubator, one or more environmental parameters of the chamber over a duration of operation of the infant incubator based on the controlling, the one or more environmental parameters selected from the group consisting of: a temperature within the chamber, a humidity level within the chamber, and an oxygen level within the chamber.

17. The method of claim 16, further comprising:
monitoring, by the infant incubator, respective values of the one or more environmental parameters over the duration of operation as measured via one or more sensors, and wherein the regulating comprises dynamically adjusting the amount based on optimization criteria for respective values of the environmental parameters.

18. The method of claim 12, further comprising:
controlling, by the infant incubator, an airflow pattern of the ionic wind airflow as generated by the one or more ionic wind modules.

19. A non-transitory machine-readable storage medium, comprising executable instructions that, when executed by a processor operatively coupled to an infant incubator, facilitate performance of operations, comprising:
employing or more ionic wind modules to generate an ionic wind airflow within a chamber of the infant incubator adapted to enclose or partially enclose an infant placed therein.

20. The non-transitory machine-readable storage medium of claim 19, wherein the operations further comprise:
controlling generation of the ionic wind airflow by the one or more ionic wind modules, including timing of the generation and an amount of the ionic wind airflow respectively generated by the one or more ionic wind modules.
